(19) United States
(12) Patent Application Publication
(10) Pub. No.: US 2025/0286796 A1
(43) Pub. Date: Sep. 11, 2025

(54) ENHANCED REPORTING OF QUALITY-OF-EXPERIENCE (QOE) MEASUREMENTS

(71) Applicant: Telefonaktiebolaget LM Ericsson (publ), Stockholm (SE)

(72) Inventors: Attila BÁDER, Paty (HU); Ferenc SZÁSZ, Budapest (HU); Peter SCHVARCZ-FEKETE, Dunaharaszti (HU); Gergely DÉVAI, Budapest (HU)

(73) Assignee: Telefonaktiebolaget LM Ericsson (publ), Stockholm (SE)

(21) Appl. No.: 18/861,210

(22) PCT Filed: May 19, 2022
(86) PCT No.: PCT/IB2022/054708

§ 371 Date: Oct. 28, 2024

(51) Int. Cl. H04L 43/062; H04W 24/10

(52) U.S. Cl. CPC H04L 43/062; H04W 24/10

(57) ABSTRACT

Embodiments include methods for a user equipment (UE) configured to report quality of experience (QoE) measurements in a radio access network (RAN). Such methods include monitoring performance of one or more services, of a UE application layer, that communicate with corresponding one or more application servers via the RAN. Such methods include, based on the monitoring, detecting one or more incidents that negatively affect user QoE and classifying each of the incidents as one of a plurality of categories of severity. Such methods include sending to a RAN node a message that includes the following: a QoE incident report that includes at least one count of incidents during a measurement period, with each count corresponding to a different category of severity; and results of radio measurements performed by a UE radio layer during the measurement period. Other embodiments include complementary methods for a network node or function (NNF).

### TECHNICAL FIELD

The present invention generally relates to wireless communication networks and particularly relates to measuring end-user experience in wireless networks, also referred to as quality of experience (QoE).

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

Currently the fifth generation (“5G”) of cellular systems, also referred to as New Radio (NR), is being standardized within the Third-Generation Partnership Project (3GPP). NR is developed for maximum flexibility to support a variety of different use cases. These include enhanced mobile broadband (eMBB), machine type communications (MTC), ultra-reliable low latency communications (URLLC), side-link device-to-device (D2D), and several others. 5G/NR technology shares many similarities with fourth-generation LTE. For example, both PHYs utilize similar arrangements of time-domain physical resources into 1-ms subframes that include multiple slots of equal duration, with each slot including multiple OFDM-based symbols.

Quality of Experience (QoE) measurements have been specified for UEs operating in LTE networks and in earlier-generation UMTS networks. Measurements in both networks operate according to the same high-level principles. Their purpose is to measure the experience of end users when using certain applications over a network. For example, QoE measurements for streaming services and for MTSI (Mobility Telephony Service for IMS) are specified for LTE.

In conventional LTE operation, radio resource control (RRC) signaling is used to configure application layer measurements in user equipment (UEs) and to collect QoE measurement result files from the configured UEs. More specifically, the LTE core network (called EPC) or a network operations/administration/maintenance (OAM) function encapsulates an application layer measurement configuration in a transparent container and sends it to a UE's serving LTE base station (called eNB), which forwards it to the UE in an RRC message. Application layer measurements made by the UE are encapsulated in a transparent container and sent to the serving eNB in an RRC message. The serving eNB then forwards the container to a Trace Collector Entity (TCE) or a Measurement Collection Entity (MCE) associated with the EPC.

Other conventional techniques for Customer Experience Management (CEM) are part of the Network Management domain, such as in in Network Operation Centers (NOC) and Service Operation Centers (SOC). These techniques monitor and analyze service and network quality on subscriber level and are often referred to as Network Optimization Engineering and/or Network Performance Management.

Typically, a NOC continuously monitors various key performance indicators (KPIs) of a network. These KPIs are based on events at network nodes and counters maintained by the network nodes, and can be aggregated in various dimension including time, node, device type, service provider, etc. In general, KPIs can indicate node or network failures but are usually not detailed enough for troubleshooting and are generally unsuitable for identifying e2e, user-perceived service quality issues.

Other conventional techniques are based on advanced analytics systems that collect and correlate elementary network events with end-to-end (e2e) service quality metrics and use this information to estimate user-level e2e key performance indicators (KPIs). These types of solutions are suitable for session-based troubleshooting and analysis of network issues.

Event-based subscriber analytics for CEM is also used in SOCs to monitor quality of various of services on a network level and to monitor customer experience on a per-subscriber level. Event-based analytics require real-time collection and correlation of node- and protocol-related events from different radio and core network nodes, probing of signaling interfaces, and sampling of user-plane traffic. The collected and correlated data is then handled by advanced databases, rule engines, and “big data” analytics platforms.

To summarize, there are various conventional techniques for estimating end-user QoE in a wireless network. The least intrusive is to use network-reported metrics to calculate a rough QoE estimate, but accuracy may inadequate. A more sophisticated and accurate technique is to install user-plane (UP) probes in the wireless network, monitor subscriber traffic, and derive QoE KPI's that can be correlated to network metrics. However, probing is very resource-intensive and requires significant technical expertise to develop analytics platforms (e.g., machine learning (ML) models) to handle the collected/correlated data.

Other techniques can be used external to a wireless network. For example, various service providers (e.g., Netflix) collect their own services metrics, which can be brought back to a wireless (e.g., 5G) network using an Application Function (AF) with interface to a service back-end. One advantage of this technique is that the e2e QoE can be precisely measured at the end device.

### SUMMARY

As briefly mentioned above, 5G networks are expected to provide a wider variety of new service types and more differentiated service quality to a larger number and wider variety of UEs than LTE and previous generation networks. This will significantly increase the incoming event rate and type to be processed by network analytics systems to determine QoE. At a minimum, the increased 5G traffic, the separation of UP from control plane (CP), and possible encryption of data to be probed significantly increases the complexity of probing techniques, and may make them unfeasible.

Moreover, AFs with back-end service interfaces are not widely available since they are service specific, requiring a network operator to make an agreement with each of the many different service providers for a different back-end interface. Even if these agreements are in place, service provider metrics are generally non-transparent to and non-correlated with network conditions, and are generally not available in real-time.

Embodiments of the present disclosure provide specific improvements to QoE measurement in a wireless network, such as by facilitating solutions to overcome exemplary problems summarized above and described in more detail below.

Embodiments of the present disclosure include methods (e.g., procedures) for a UE configured to report QoE measurements in a RAN.

These exemplary methods can include monitoring performance of one or more services, of a UE application layer, that communicate with corresponding one or more application servers via the RAN. These exemplary methods can also include, based on the monitoring, detecting one or more incidents that negatively affect user QoE and classifying each of the incidents as one of a plurality of categories of severity. These exemplary methods can also include sending to a RAN node, a message that includes the following:
a QoE incident report that includes at least one count of incidents during a measurement period, with each count corresponding to a different category of severity; and
results of radio measurements performed by a UE radio layer during the measurement period.

In some embodiments, the plurality of categories of severity include the following:
a first category of critical problems, such that the corresponding service cannot be used;
a second category of major problems, such that the corresponding service is usable but user QoE is seriously degraded; and
a third category of medium problems, such that user QoE for the corresponding service is degraded but less than for a major problem.

In some embodiments, the QoE incident report sent to the RAN node includes only non-zero counts of incidents during the measurement period.

In some embodiments, the monitoring, detecting, and classifying operations are performed by the respective services of the UE application layer and the sending operation is performed by the UE radio layer. In some of these embodiments, these exemplary methods can also include, in response to each incident classified by a particular service, the particular service sending to the UE radio layer a QoE incident report that includes an identifier of the service and the category of severity of the incident, and the UE radio layer incrementing a counter corresponding to category of severity indicated by incident report.

In some of these embodiments, the at least one count of incidents in the QoE incident report comprises values of the respective counters at the end of the measurement period, limited to a predetermined maximum count. In some of these embodiments, the at least one count of incidents in the QoE incident report excludes categories of severity whose corresponding counters are zero at the end of the measurement period. In some of these embodiments, these exemplary methods can also include the UE radio layer resetting the respective counters at or before the beginning of each measurement period.

In other of these embodiments, these exemplary methods can also include, in response to each incident classified by a particular service, the particular service incrementing a counter corresponding to category of severity of the incident and then the respective services sending to the UE radio layer respective service QoE incident reports for the measurement period. Each service QoE incident report includes an identifier of the service and values of the service's respective counters at the end of the measurement period.

In some of these embodiments, the one or more services include a plurality of services and these exemplary methods also include, for each category of severity, the UE radio layer aggregating the values of corresponding counters in the respective service QoE incident reports for the measurement period. In such case, the QoE incident report sent to the RAN node includes the aggregated values, limited to a predetermined maximum count. In some of these embodiments, each service QoE incident report excludes categories of severity whose corresponding counters are zero at the end of the measurement period.

In some of these embodiments, these exemplary methods can also include, in response to the end of the measurement period, the UE radio layer sending to the one or more services respective requests for service QoE incident reports. The service QoE incident reports are sent by the respective services in response to the requests. In some of these embodiments, these exemplary methods can also include the one or more services resetting their respective counters in response to one of the following: sending the service QoE incident report, or receiving the request for a service QoE incident report.

In some embodiments, the message comprises a radio resource control (RRC) MeasResults information element (IE) that includes the QoE incident report and the results of the radio measurements. FIG. 7 shows an example of these embodiments.

In some embodiments, the one or more services communicate with corresponding one or more application servers via the UE's serving cell in the RAN and the results of the radio measurements are for the UE's serving cell and one or more neighbor cells in the RAN.

Other embodiments include methods (e.g., procedures) for a network node or function (NNF) configured to receive UE QoE measurements in a RAN.

These exemplary methods can include receiving a message that includes a QoE incident report and results of radio measurements performed by a UE radio layer during the measurement period. The QoE incident report includes at least one count of incidents that negatively affect user QoE during a measurement period. Each count corresponds to a different one of a plurality of categories of severity and each incident is associated with a service of a UE application layer that includes one or more services that communicate with corresponding one or more application servers via the RAN.

In various embodiments, the plurality of categories of severity include the ones summarized above for UE embodiments.

In some embodiments, the NNF is a RAN node, the message is received from the UE, and these exemplary methods also include sending the QoE incident report and the results of the radio measurements to one or more of the following: a network data analytics function (NWDAF) of a core network (e.g., 5GC) coupled to the RAN, and a management data analytics function (MDAF) of an operations administration maintenance (OAM) system coupled to the RAN. In some of these embodiments, the received message comprises an RRC MeasResults IE that includes the QoE incident report and the results of the radio measurements.

In other embodiments, the NNF is an NWDAF of a core network (e.g., 5GC) coupled to the RAN or an MDAF of an OAM system coupled to the RAN, and the message is received from a RAN node that serves the UE. In such embodiments, these exemplary methods can also include one or more of the following operations:
computing one or more QoE key performance indicators (KPIs) based on the QoE incident report;
detecting one or more radio-related problems in the RAN based on the QoE incident report and the results of the radio measurements; and
detecting one or more problems in a core network coupled to the RAN, based on the QoE incident report and the results of the radio measurements.

Other embodiments include UEs (e.g., wireless devices, IoT devices, etc. or component(s) thereof) and NNFs (e.g., base stations, eNBs, gNBs, ng-eNBs, MDAFs, NWDAFs, etc.) configured to perform operations corresponding to any of the exemplary methods described herein. Other embodiments include non-transitory, computer-readable media storing program instructions that, when executed by processing circuitry, configure such UEs or NNFs to perform operations corresponding to any of the exemplary methods described herein.

These and other embodiments described herein can facilitate more precise QoE estimation than conventional techniques that use QoE machine learning (ML) models. Embodiments can provide QoE-related information in real-time (RT) or near-real time (NRT), which allows using QoE as target optimization parameter in RT or NRT control loops for radio and core self-optimizing network (SON) features. Since QoE and radio-related information are measured during the same period and reported at the same time, QoE incidents are well correlated with underlying radio-related issues, which facilitates root cause identification.

Embodiments also require very little additional measurement collection and reporting, and eliminate or reduce requirements for operators to make agreements with various service providers for back-end interfaces to obtain service provider QoE data. Embodiments provide benefits for both network operators and service providers, which can facilitate and/or encourage implementation of the disclosed techniques by both types of entities.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary LTE network architecture.

FIG. 2 shows a high-level view of an exemplary 5G/NR network architecture.

FIG. 3 shows an exemplary LTE control plane (CP) protocol stack.

FIG. 4 shows an exemplary NR CP and user plane (UP) protocol stack.

FIG. 5 shows an exemplary non-roaming reference architecture for a 5G network.

FIG. 6 shows an exemplary high-level view of various functionality within a network operator domain.

FIG. 7 shows an exemplary ASN.1 data structure for a radio resource control (RRC) MeasResult information element (IE), according to various embodiments of the present disclosure.

FIGS. 8-9 show signal flow diagrams of exemplary QoE incident reporting procedures, according to various embodiments of the present disclosure.

FIG. 10 is a flow diagram of an exemplary method (e.g., procedure) for a UE (e.g., wireless device), according to various exemplary embodiments of the present disclosure.

FIG. 11 is a flow diagram of an exemplary method (e.g., procedure) for a network node or function (NNF), according to various exemplary embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB/en-gNB) in a 3GPP 5G/NR network or an enhanced or evolved Node B (eNB/ng-eNB) in a 3GPP LTE network), base station distributed components (e.g., CU and DU), base station control- and/or user-plane components (e.g., CU-CP, CU-UP), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

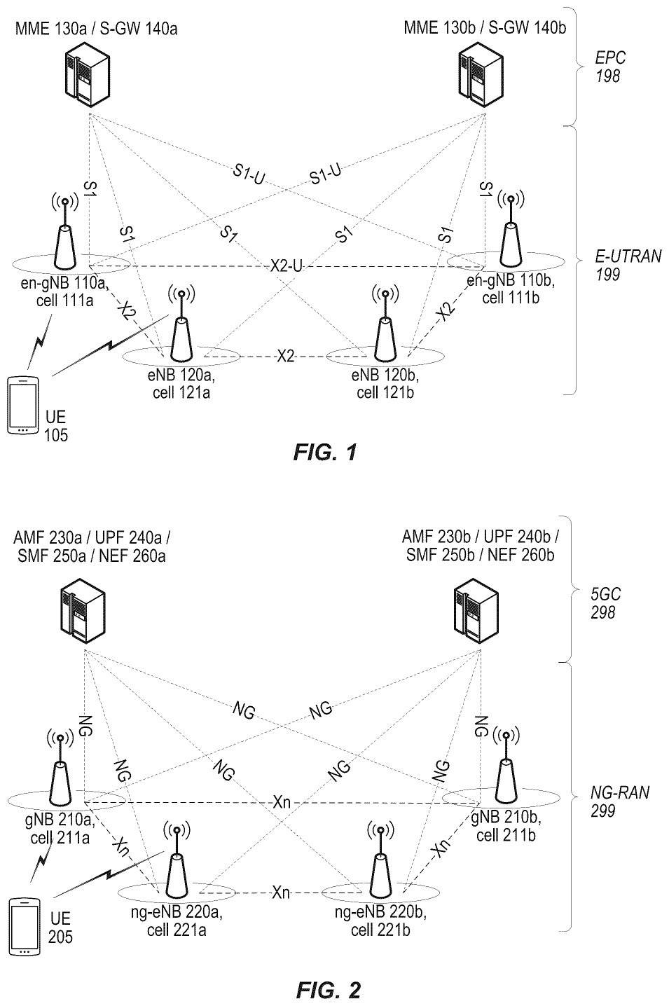

FIG. 1 shows a high-level view of an exemplary LTE network architecture, including an E-UTRAN 199 and an EPC 198. E-UTRAN 199 is responsible for all radio-related functions in the network, including radio bearer control, radio admission control, radio mobility control, scheduling, and dynamic allocation of resources to UEs in uplink and downlink, as well as security of the communications with the UE. These functions reside in the base stations, e.g., eNBs 120a,b that provide the LTE radio interface. E-UTRAN 199 is also shown as including en-gNBs 110a,b that provide the NR radio interface, but these are optional.

Each of the eNBs and en-gNBs serves a geographic coverage area including one more cells, such as cells 111a-b and 121a-b shown as exemplary in FIG. 1. Depending on the cell in which it is located, a UE 105 can communicate with an en-gNB or eNB serving that cell via the NR or LTE radio interface, respectively. The eNBs and en-gNBs are interconnected with each other via respective X2 (or X2-U) interfaces, and to EPC 198 via respective S1 (or S1-U) interfaces.

EPC 198 includes one or more Mobility Management Entities (MMEs, e.g., 130a,b) and one or more Serving Gateways (SGW, e.g., 140a,b). In general, MME and S-GW handle the overall control of the UE and data flow between the UE and the rest of the EPC. More specifically, the MME processes the signaling (e.g., CP) protocols between the UE and the EPC, which are known as the Non-Access Stratum (NAS) protocols. The S-GW handles all Internet Protocol (IP) data packets (e.g., data or UP) between the UE and the EPC and serves as the local mobility anchor for the data bearers when the UE moves between eNBs and/or en-gNBs.

Although not shown in FIG. 1, EPC 198 can also include a Home Subscriber Server (HSS), which manages user- and subscriber-related information. The HSS can also provide support functions for mobility management, call and session setup, user authentication and access authorization. In some arrangements, EPC 198 can also include a user data repository (UDR) that stores user credentials after they have been encrypted.

FIG. 2 shows a high-level view of an exemplary NR network architecture, including a next-generation RAN (NG-RAN) 299 and a 5G core network (5GC) 298. Like EPC 199 in FIG. 1, NG-RAN 299 is responsible for all radio-related functions in the network. These functions reside in the base stations, e.g., gNBs 210a,b that provide the NR radio interface. NG-RAN 299 is also shown as including ng-eNBs 220a,b that provide the LTE radio interface, but these are optional.

Each of the gNBs and ng-eNBs serves a geographic coverage area including one more cells, such as cells 211a-b and 221a-b shown as exemplary in FIG. 2. Depending on the cell in which it is located, a UE 205 can communicate with a gNB or ng-eNB serving that cell via the NR or LTE radio interface, respectively. The gNBs and ng-eNBs are interconnected with each other via respective Xn interfaces, and to 5GC 298 via respective NG interfaces.

5GC 298 includes one or more Access and Mobility Management Functions (AMFs, e.g., AMFs 230a,b) and one or more User Plane Functions (UPFs, e.g., 240a,b). The gNBs and ng-eNBs connect to UPFs via respective NG-U interfaces and to the AMFs via respective NG-C interfaces. The AMFs can also communicate with one or more Session Management Functions (SMFs, e.g., 250a,b) and one or more Network Exposure Functions (NEFs, e.g., 260a,b).

The gNBs shown in FIG. 2 can include a central (or centralized) unit (CU or gNB-CU) and one or more distributed (or decentralized) units (DU or gNB-DU). CUs are logical nodes that host higher-layer protocols and perform various gNB functions such as RRC signaling with UEs and controlling DU operations. DUs are logical nodes that host lower-layer protocols and can include various subsets of the gNB functions. As such, each of the CUs and DUs can include various circuitry needed to perform their respective functions, including processing circuitry, transceiver circuitry (e.g., for communication), and power supply circuitry.

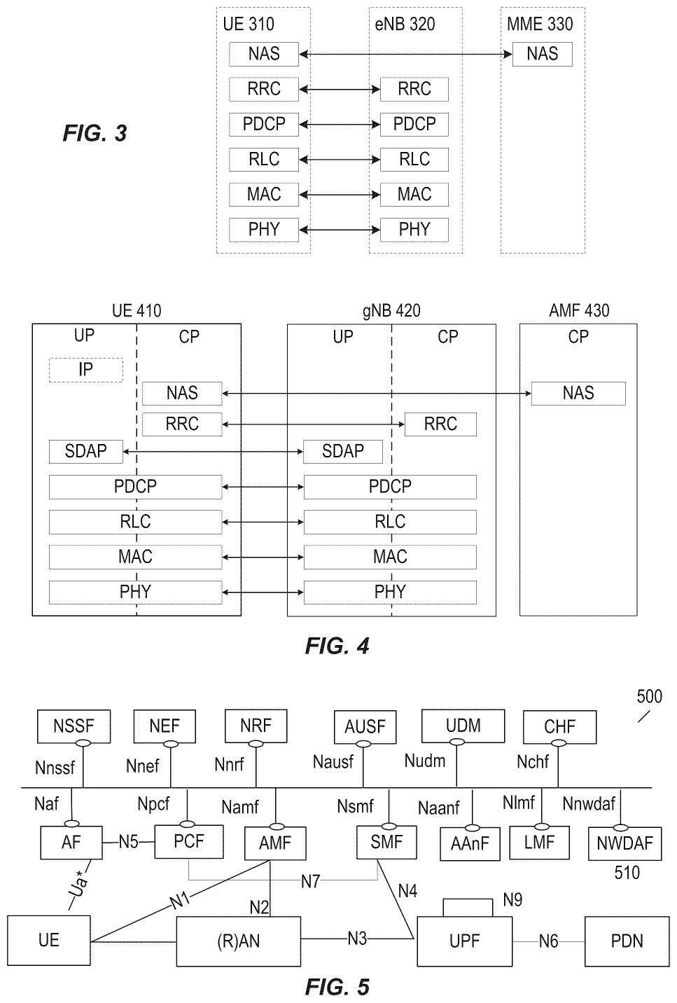

FIG. 3 illustrates an exemplary LTE CP protocol stack between a UE (310), an eNB (320), and an MME (330), such as those shown in FIG. 1. The exemplary protocol stack includes Physical (PHY), Medium Access Control (MAC), Radio Link Control (RLC), Packet Data Convergence Protocol (PDCP), and Radio Resource Control (RRC) layers between the UE and CNB.

The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both CP and UP, as well as other UP functions such as header compression. The exemplary protocol stack also includes non-access stratum (NAS) signaling between the UE and the MME.

The RRC layer controls communications between a UE and an eNB at the radio interface, as well as the mobility of a UE between cells in the E-UTRAN. After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_ IDLE state, the UE does not belong to any cell, no RRC context has been established for the UE (e.g., in E-UTRAN), and the UE is out of UL synchronization with the network. Even so, a UE in RRC_IDLE state is known in the EPC and has an assigned IP address.

Furthermore, in RRC_IDLE state, the UE's radio is active on a discontinuous reception (DRX) schedule configured by upper layers. During DRX active periods (also referred to as “DRX On durations”), an RRC_IDLE UE receives system information (SI) broadcast by a serving cell, performs measurements of neighbor cells to support cell reselection, and monitors a paging channel for pages from the EPC via an eNB serving the cell in which the UE is camping.

A UE must perform a random-access (RA) procedure to move from RRC_IDLE to RRC_CONNECTED state. In RRC_CONNECTED state, the cell serving the UE is known and an RRC context is established for the UE in the serving eNB, such that the UE and eNB can communicate. For example, a Cell Radio Network Temporary Identifier (C-RNTI)—a UE identity used for signaling between UE and network—is configured for a UE in RRC_CONNECTED state.

FIG. 4 shows an exemplary NR UP and CP protocol stack between a UE (410), a gNB (420), and an AMF (430), such as those shown in FIG. 2. The PHY, MAC, RLC, and PDCP layers between UE and gNB are common to UP and CP. Although the NR layers shown in FIG. 4 have similar functionality as corresponding LTE layers in FIG. 3, certain aspects of the NR layers are described in more detail below.

On the UP side, Internet protocol (IP) packets arrive to the PDCP layer as service data units (SDUs), and PDCP creates protocol data units (PDUs) to deliver to RLC. When each IP packet arrives, PDCP starts a discard timer. When this timer expires, PDCP discards the associated SDU and the corresponding PDU. If the PDU was delivered to RLC, PDCP also indicates the discard to RLC.

The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On UP side, the Service Data Adaptation Protocol (SDAP) layer handles quality-of-service (QOS). This includes mapping between QoS flows and Data Radio Bearers (DRBs) and marking QoS flow identifiers (QFI) in UL and DL packets. On CP side, the non-access stratum (NAS) layer is between UE and AMF and handles UE/gNB authentication, mobility management, and security control.

The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and SRBs used by UEs. Additionally, RRC controls addition, modification, and release of CA and DC configurations for UEs. RRC also performs various security functions such as key management. The NR RRC layer includes RRC_IDLE and RRC_CONNECTED states found in the LTE RRC layer, but adds another state known as RRC_INACTIVE.

When a UE is in RRC_CONNECTED state, it can send the network measurement reports that include radio quality metrics for serving cell and neighbor cells, such as reference signal received power (RSRP), reference signal received quality (RSRQ), signal-to-interference-and-noise ratio (SINR), etc. The UE's measurements and reporting are based on configurations provided by the network. For example, the network can configure the UE to send a measurement report upon an A1 event (serving cell becomes better than threshold), an A2 event (serving cell becomes worse than threshold), a B1 event (inter-RAT neighbor becomes better than threshold), etc. In addition, the network can configure the UE to perform periodic measurement reporting.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

FIG. 5 shows an exemplary non-roaming reference architecture for a 5G network (500). These include the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the NI reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface-based in a user's home network (HPLMN), it performs user authentication and computes security key materials for various purposes.
Network Data Analytics Function (NWDAF, 510) with Nnwdaf interface, described in more detail above and below.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

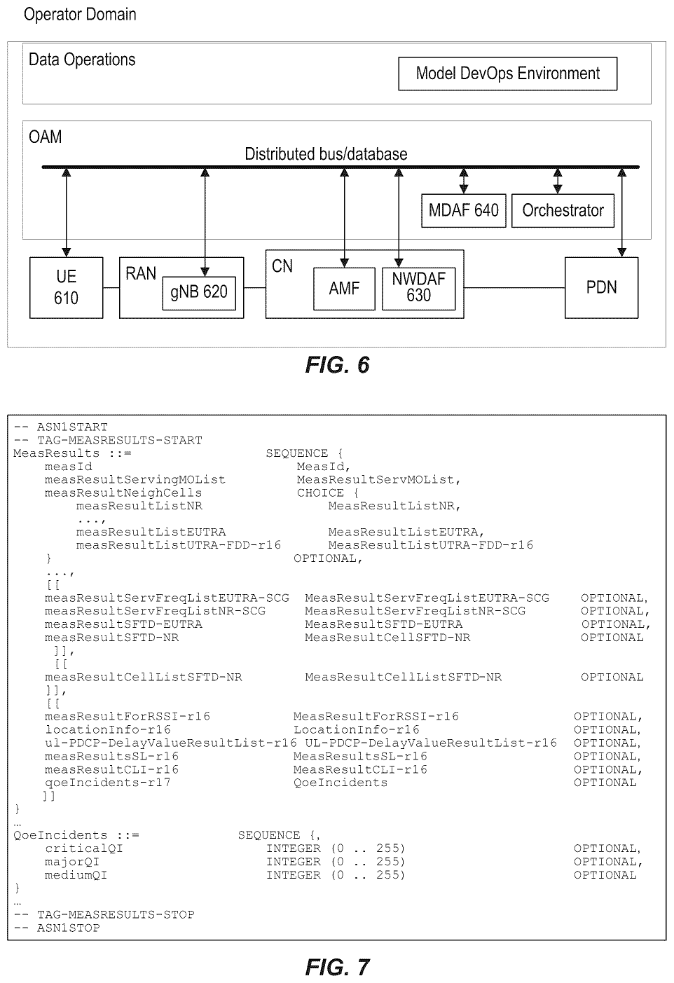

FIG. 6 shows an exemplary high-level view of various functionality within a network operator domain. At the bottom are various entities discussed above, including UE (610), RAN (with gNB 620), core network (CN) including AMF and NWDAF (630), and packet data network (PDN). At the next level is the operator's operations/administration/maintenance (OAM) domain. The OAM domain includes management of the various entities on the bottom layer as well as orchestration on various levels and all Operational Support System (OSS) functions such as end-to-end management of users/services/network slices. The various entities can expose data to a distributed bus/database in the OAM domain, as illustrated by the lines with arrows shown in FIG. 6. This can be done, for example, using software probes.

Network analytics functions inside the operator domain can provide insights for user experience and service/application management that enhance the network functionality. Two examples are the NWDAF in the CN and the Management Data Analytics Function (MDAF, 640) shown in the OAM domain in FIG. 6. MDAF can be deployed at a domain level (e.g., RAN or CN) or for end-to-end analytics as part of the overall OAM.

These analytics functions have capabilities such as measuring and predicting perceived customer experience; ingesting, auditing, and contextualizing data for service assurance and network operations; and detecting incidents, performing root cause analysis, and recommending solutions. More specifically, in the OAM domain, data may be used for optimizing network management, customer experience analytics, service assurance, incident management, etc. For example, an artificial intelligence (AI) algorithm can predict when there will be potential loss in a service (e.g., throughput degradation) and take a corrective action before the predicted problems becomes reality.

Data-driven architectures such as shown in FIG. 6 also include environments for machine learning (ML), in which an ML model is trained and then executed for prediction. Depending on specific requirements, various ML modes can be used for model training and execution, including local, central, federated, transfer, offline, and online learning. Model lifecycle management (LCM) can be divided into two phases: 1) data preparation, modelling, and validation; and 2) deployment and execution of the models themselves. For example, these operations can be performed in the Data Operations layer of the architecture shown in FIG. 6, such as in a Model DevOps Environment.

As mentioned above, there are various conventional techniques for estimating end-user QoE in a wireless network. The least intrusive is to use network-reported metrics to calculate a rough QoE estimate, but accuracy may inadequate. A more sophisticated and accurate technique is to install UP probes in the wireless network, monitor subscriber traffic, and derive QoE KPI's that can be correlated to network metrics. This can be done, for example, in the OAM domain such as shown in FIG. 6.

However, probing is very resource-intensive and although basic packet-level QoS parameters can be monitored, higher protocol layers cannot be probed due to encryption. Moreover, since relationships between QoE and the various collected data is complex and usually unknown, ML models are often used to estimate and/or predict QoE KPIs. Development of these ML models requires significant technical expertise.

Furthermore, 5G networks are expected to provide a wider variety of new service types and more differentiated service quality to a larger number and wider variety of UEs than LTE and previous generation networks. This will significantly increase the incoming event rate and type to be processed by network analytics systems to determine QoE. At a minimum, the increased traffic, UP/CP separation, and possible encryption of data to be probed significantly increases the complexity of probing techniques for 5G networks, and may make them unfeasible.

As mentioned above, various service providers (e.g., Netflix) collect their own services metrics, which can be brought back to a wireless (e.g., 5G) network using an AF with interface to a service back-end. One advantage of this technique is that the e2e QoE can be precisely measured at the end device. However, AFs with back-end service interfaces are not widely available since they are service specific, requiring a network operator to make an agreement with each of the many different service providers for a different back-end interface. Even if these agreements are in place, service provider metrics are generally non-transparent to and non-correlated with network conditions, and are generally not available in real-time.

As also mentioned above, QoE measurements have been specified for UEs operating in LTE networks and in earlier-generation UMTS networks. For LTE, application-layer measurements made by a UE are encapsulated in a transparent container and sent to the serving eNB in an RRC message. The serving eNB then forwards the container to a Trace Collector Entity (TCE) or a Measurement Collection Entity (MCE) associated with the EPC.

Similarly, UE QoE measurements made in NG-RAN may be initiated by OAM in a generic way for a group of UEs, or by the 5GC towards a specific UE based on signaling with the NG-RAN. In general, the RAN (e.g., E-UTRAN or NG-RAN) is not aware of an ongoing application session for a UE, when QoE measurements are being performed by the UE, and the contents of the measurement container. Furthermore, the container includes no information about radio- or network-related conditions at the time of the application-layer measurements. As such, currently defined UE QoE measurement procedures are unable to provide the degree of observability needed for network operators to gain detailed and/or accurate insight into end-user QoE and control/configure network operation accordingly.

Accordingly, embodiments of the present disclosure provide novel, flexible, and efficient techniques obtaining QoE information from UEs in real-time together with UE radio-related measurements. In particular, techniques involve extending an existing UE measurement report with additional information referred to as a “QoE incident report” that includes numbers of critical, major, and medium service-related issues observed by a UE during each measurement period. The QoE incident report format can facilitate efficient reporting of service quality issues by UEs, and provides correlation of such issues with radio-related measurements during the same measurement period. Moreover, such information is available real-time in cell trace or UE trace events for NWDAF and/or MDAF use.

Each application executing in a UE monitors its own service quality. If a service quality issue is detected, the application reports the issue and its severity to the UE's Radio Management Function, which summarizes the issues from all applications during the measurement period and includes the summarized values in the QoE incident report. The UE includes this report together with radio-related measurements made by the UE in a measurement report (e.g., RRC message) sent to its serving RAN node (e.g., gNB). The RAN node can send the UE's measurement report (including a QoE incident report) to NWDAF and/or MDAF, which correlates this information with other network events, calculates QoE-related KPIs, and (optionally) aggregates QoE KPIs and/or underlying QoE incidents for different times, network parameters/settings, and user parameters/settings.

Embodiments can provide various benefits, advantages, and/or solutions to problems described herein. For example, embodiments facilitate more precise QoE estimation than conventional techniques that use QoE ML models based on QoS or other network parameters. As another example, embodiments provide QoE-related information in real-time (RT) or near-real time (NRT), which allows using QoE as target optimization parameter in RT or NRT control loops for radio and core self-optimizing network (SON) features. In particular, the reporting period for QoE information can be aligned with radio-related measurement reports. Moreover, since QoE and radio-related information are measured during the same period and reported at the same time, QoE incidents are well correlated with underlying radio-related issues, which facilitates root cause identification.

Furthermore, embodiments require very little additional measurement collection and reporting. Reporting is only done when there are QoE incidents to report, and in an efficient format of a fixed number of (e.g., three) levels of severity. In contrast, conventional QoE values (or KPIs) must be reported even when their values would suggest no QoE incidents.

Additionally, embodiments do not require operators to make agreements with various service providers for back-end interfaces to obtain service provider QoE data. In fact, embodiments provide benefits for both network operators and service providers, which can facilitate and/or encourage implementation of the disclosed techniques by both types of entities.

In the following description of embodiments, the following groups of terms and/or abbreviations have the same or substantially similar meanings and, as such, may be used interchangeably and/or synonymously unless specifically noted or unless a different meaning is clear from a specific context of use:
“service” and “application”;
“application layer” and “UE application layer”;
“application-layer measurement” and “QoE measurement”; and
“radio layer”, “UE radio layer”, “RRC layer”, and “access layer”.

FIG. 7 shows an exemplary ASN. 1 data structure for an RRC MeasResult information element (IE) by which a UE can send a QoE incident report together with radio-related measurements, according to various embodiments of the present disclosure. In particular, FIG. 7 extends an existing NR RRC MeasResult IE defined in 3GPP TS 38.331 (v16.7.0) to include an additional qoeIncidents-r17 IE that includes the following fields:
criticalQI—identifies total number of critical errors detected by all UE applications in the cell for which the reporting is being performed, as an integer in the range 0-255;
majorQI—identifies total number of major errors detected by all UE applications in the cell for which the reporting is being performed, as an integer in the range 0-255; and
mediumQI—identifies total number of medium errors detected by all UE applications in the cell for which the reporting is being performed, as an integer in the range 0-255.

Similar extensions can be defined for an LTE RRC MeasResult IE defined in 3GPP TS 36.331 (v16.7.0). Although extending existing RRC measurement reporting to include QoE incidents is convenient because, the UE can also report QoE incident information via other existing or newly-defined reporting procedures, as needed and/or desired.

The categories of “critical”, “major”, and “medium” can be defined in various ways. The following is one example:
Critical: when the service is broken and cannot be used;
Major: when the perceived service experience is seriously degraded (very slow, there are high delays or service is frequently interrupted);
Medium: when degraded service quality can affect the user experience, but to a lesser degree than a major or critical problem.

More generally, QoE degradation depends on the application type. Service providers have knowledge of both application server and UE application client and, in some cases, can collect QoE labels by asking users to rate service quality. From this information, service providers can create algorithms and/or models to determine QoE degradation needed by the application client to detect/categorize problems reported in the manner described above.

The above example provides three categories (critical, major, medium) and puts an upper limit of 255 on the number of incidents per category per measurement period. One reason for these limitations is to reduce reporting burden, which would increase with more categories and high incident counts. Moreover, even 255 incidents during a reporting period indicates a problem needing to be addressed, such that the ability to report even more incidents provides little additional benefit.

Nevertheless, the actual maximum number of incidents per category is a design and/or implementation choice that should consider number of applications expected to be running in a UE, expected measurement period(s), available reporting capacity, etc. Likewise, the number of categories is also a design and/or implementation choice that should consider application characteristics, types of corrective actions available, available reporting capacity, etc.

Note that embodiments described above report QoE incidents rather than QoE KPIs. However, QoE KPIs can still be calculated by existing NWDAF and/or MDAF (or similar), and existing QoE KPIs can be extended and/or enhanced based on the additional information provided by QoE incident reports (e.g., number, frequency, and severity of QoE incidents).

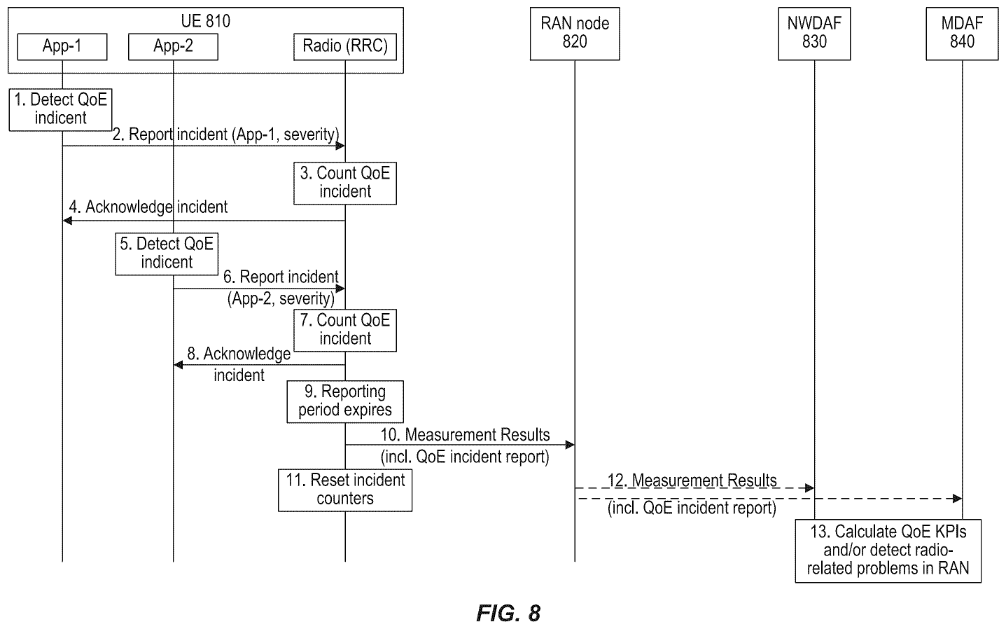

FIG. 8 shows a signal flow diagram of an exemplary QoE incident reporting procedure, according to various embodiments of the present disclosure. In particular, the exemplary QoE reporting procedure is between a UE (810), a RAN node (820, e.g., gNB), an NWDAF (830), and an MDAF (840). The UE includes two applications and a radio (e.g., RRC) layer that performs measurement reporting to the RAN node. Although the operations shown in FIG. 8 are given numerical labels, this is done to facilitate the following explanation rather than to imply a sequential ordering of operations, unless stated to the contrary below.

In operation 1, Application 1 (App-1) detects a QoE incident of a particular severity level, according to the range of severity levels configured for App-1. In operation 2, App-1 sends the radio layer a QoE incident report that identifies App-1 and the detected severity level. In operations 3-4, the radio layer increments its incident counter corresponding to the severity level indicated in the received report and sends an acknowledgement to App-1.

In operation 5, Application 2 (App-2) detects a QoE incident of a particular severity level, according to the range of severity levels configured for App-2. In operation 6, App-2 sends the radio layer a QoE incident report that identifies App-2 and the detected severity level. In operations 7-8, the radio layer increments its incident counter corresponding to the severity level indicated in the received report and sends an acknowledgement to App-2.

The UE's measurement reporting period expires in operation 9, causing the radio layer to compile a QoE incident report based on the incident counters for the respective severity levels, and send measurement results including the QoE incident report to the RAN node in operation 10. For example, the radio layer can send a measurement report that includes an RRC MeasResults IE such as shown in FIG. 7. Note that the QoE incident report only includes severity levels with non-zero incident counts (i.e., excluding values of counters that are zero), which is facilitated by the “OPTIONAL” designation given each of the fields of QoEIncidents in FIG. 7. Also, the incident counts may also be limited to maximum values, such as 255 shown in FIG. 7. This may be done by the radio layer refraining from incrementing a counter after it reaches the maximum value, or by the radio layer limiting the actual counts to the maximum before including them in the report.

In operation 11, the RAN node resets its incident counters after or in conjunction with sending the report in operation 10, such that the QoE incident counts start from zero for the next reporting period. In operation 12 (optional), the RAN node sends or forwards the measurement results (including the QoE incident report) to the NWDAF and/or to the MDAF, depending on which of these functions are deployed and configured to utilize such information.

The NWDAF and/or MDAF that receives the measurement results then uses them in operation 13 to compute QoE KPIs and/or detect one or more radio-related problems in the RAN. Note that these QoE KPIs and/or detected problems may be based on such measurement results reported by the same UE over multiple reporting periods and/or other UEs over one or multiple reporting periods. Some example QoE KPIs include:
Number of QoE incidents per cell and per severity category over a time period, e.g., one hour. This KPI depends on the number of active subscribers per cell and frequency of radio-related problems/issues. As such, this KPI can be used for identifying and focusing on cells where issues affect many UEs/subscribers.
Number of users in cells where number of critical QoE incidents are more than a limit.
Ratio of subscribers with at least one critical QoE incident per cell. Compared to counting KPIs such as above, this KPI is independent of the number of active subscribers in a cell. As such, this KPI can be used for identifying cells with worse coverage, most probable handover issues, etc.
Ratio of QoE incidents per UE type, per UE software version, etc. For example, this KPI can be used for identifying underperforming UE types, software versions, etc.

An example of detecting radio-related problems based on the QoE incident report and the measurement results is the NWDAF and/or MDAF correlating RSRP/RSRQ measurements with the QoE incident reports and identifying coverage or interference problems based on this information. More specifically, the NWDAF and/or MDAF can identify a cell with a high number of QoE incidents and check reported RSRP/RSRQ measurements for this cell. If average RSRP is below −115 dBm, then a coverage issue is detected for this cell. If average RSRQ is below −20 dB, then an interference issue is detected for this cell. Alternately or additionally, the NWDAF and/or MDAF can also determine what level of cell overload actually causes QoE incidents that negatively affect user QoE.

In some embodiments, the NWDAF and/or MDAF can also detect one or more problems in a core network (CN, e.g., 5GC) coupled to the RAN, based on the QoE incident report and the results of the radio measurements. For example, if the QoE incident report indicates a relatively high number of QoE incidents that negatively affect QoE but the measurement results indicate good (or at least adequate) coverage and interference level, then the NWDAF and/or MDAF can detect a CN dimensioning problem, such as insufficient UPF capacity in the network slice to which the user is assigned.

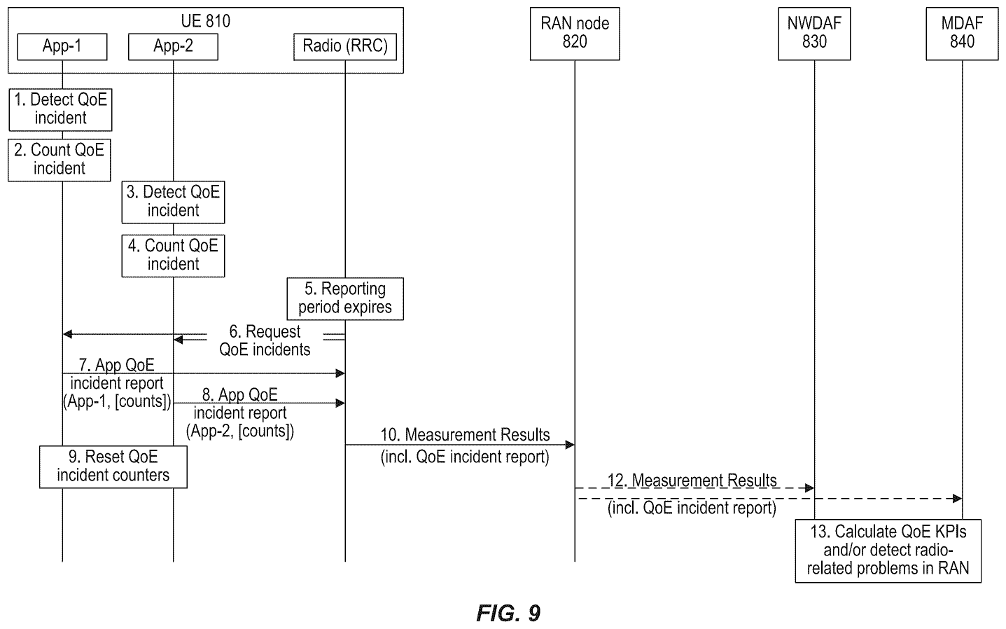

FIG. 9 shows a signal flow diagram of another exemplary QoE incident reporting procedure, according to other embodiments of the present disclosure. In particular, the exemplary QoE reporting procedure is between a UE, a RAN node (e.g., gNB), an NWDAF, and an MDAF, with those entities having identical reference numbers as in FIG. 8. The UE includes two applications and a radio (e.g., RRC) layer that performs measurement reporting to the RAN node. Although the operations shown in FIG. 9 are given numerical labels, this is done to facilitate the following explanation rather than to imply a sequential ordering of operations, unless stated to the contrary below.

In operation 1, App-1 detects a QoE incident of a particular severity category, according to the range of severity levels configured for App-1. In operation 2, App-1 increments its incident counter corresponding to that severity category. In operation 3, App-2 detects a QoE incident of a particular severity category, according to the range of severity levels configured for App-2. In operation 4, App-2 increments its incident counter corresponding to that severity category. Note that operations 1-4 may be repeated multiple times during a reporting period, according to conditions experienced by the respective applications.

The UE's measurement reporting period expires in operation 5, causing the radio layer to request QoE incident reporting by App-1 and App-2 in operation 6. In operation 7, App-1 sends the radio layer an application QoE incident report that identifies App-1 and includes counts of the QoE incidents detected during the most recent measurement period, according to severity categories. In other words, App-1 sends the radio layer the values of respective incident counters that it maintains. Note that the application QoE incident report may only include severity levels with non-zero incident counts, like the fields of QoEIncidents IE in FIG. 7. Also, the application incident counts may also be limited to maximum values, such as 255. This may be done by the application refraining from incrementing a counter after it reaches the maximum value, or by the application limiting the actual counts to the maximum before including them in the application QoE incident report to the radio layer.

In operation 9, App-1 and App-2 reset their respective incident counters to zero for the new measurement period. This can be done in response to receiving the request in operation 6 or in response to sending the application QoE incident report in operation 7 or 8. In operation 10, the RAN node can aggregate QoE incident reports received from App-1 and App-2 (and any other reporting applications) into a UE-level QoE incident report and send measurement results including the QoE incident report to the RAN node. For example, the radio layer can send a measurement report that includes an RRC MeasResults IE such as shown in FIG. 7. Operations 11-13 correspond to operations 11-13 in FIG. 8, described above.

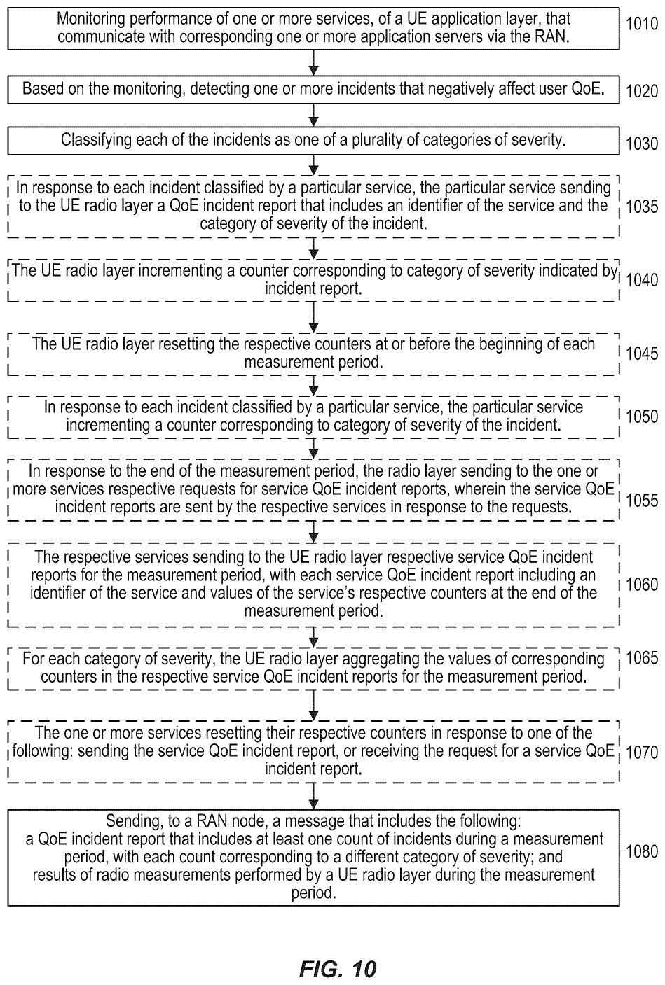

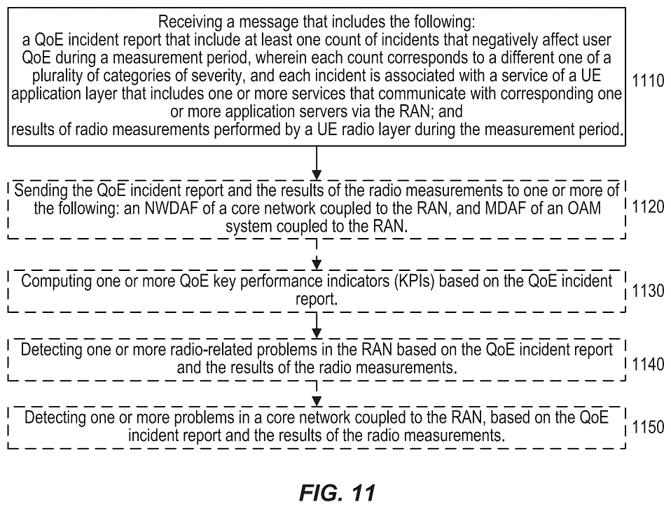

The embodiments described above can be further illustrated with reference to FIGS. 10-11, which show exemplary methods (e.g., procedures) performed by a UE and a network node or function (NNF), respectively. In other words, various features of operations described below correspond to various embodiments described above. These exemplary methods can also be used cooperatively to provide various exemplary benefits and/or advantages. Although FIGS. 10-11 show specific blocks in a particular order, the operations of the respective methods can be performed in different orders than shown and can be combined and/or divided into blocks having different functionality than shown. Optional blocks or operations are indicated by dashed lines.

In particular, FIG. 10 shows a flow diagram of an exemplary method (e.g., procedure) for a UE configured to report QoE measurements in a RAN, according to various exemplary embodiments of the present disclosure. The exemplary method can be performed by a UE (e.g., wireless device, IoT device, modem, etc. or component thereof) such as described elsewhere herein.

The exemplary method can include operations of block 1010, where the UE can monitor performance of one or more services, of a UE application layer, that communicate with corresponding one or more application servers via the RAN. The exemplary method can also include operations of block 1020, where based on the monitoring, the UE can detect one or more incidents that negatively affect user QoE. The exemplary method can also include operations of block 1030, where the UE can classify each of the incidents as one of a plurality of categories of severity. The exemplary method can also include operations of block 1080, where the UE can send, to a RAN node, a message that includes the following:
a QoE incident report that includes at least one count of incidents during a measurement period, with each count corresponding to a different category of severity; and
results of radio measurements performed by a UE radio layer during the measurement period.

In some embodiments, the plurality of categories of severity include the following:
a first category of critical problems, such that the corresponding service cannot be used;
a second category of major problems, such that the corresponding service is usable but user QoE is seriously degraded; and
a third category of medium problems, such that user QoE for the corresponding service is degraded but less than for a major problem.

In some embodiments, the QoE incident report sent to the RAN node includes only non-zero counts of incidents during the measurement period.

In some embodiments, the monitoring, detecting, and classifying operations are performed by the respective services of the UE application layer and the sending operation is performed by the UE radio layer. In some of these embodiments, the exemplary method can also include the operations of blocks 1035-1040, where in response to each incident classified by a particular service, the particular service sends to the UE radio layer a QoE incident report that includes an identifier of the service and the category of severity of the incident, and the UE radio layer increments a counter corresponding to category of severity indicated by incident report. FIG. 8 shows an example of these embodiments.

In some of these embodiments, the at least one count of incidents in the QoE incident report comprises values of the respective counters at the end of the measurement period, limited to a predetermined maximum count. In some of these embodiments, the at least one count of incidents in the QoE incident report excludes categories of severity whose corresponding counters are zero at the end of the measurement period. This is illustrated by the “OPTIONAL” designation in FIG. 7, discussed above. In some of these embodiments, the exemplary method can also include the operations of block 1045, there the UE radio layer resets the respective counters at or before the beginning of each measurement period.

In other of these embodiments, the exemplary method can also include the operations of blocks 1050 and 1060, where in response to each incident classified by a particular service, the particular service increments a counter corresponding to category of severity of the incident and then the respective services send to the UE radio layer respective service QoE incident reports for the measurement period. Each service QoE incident report includes an identifier of the service and values of the service's respective counters at the end of the measurement period. FIG. 9 shows an example of these embodiments.

In some of these embodiments, the one or more services include a plurality of services and the exemplary method also includes the operations of block 1065, where for each category of severity, the UE radio layer aggregates the values of corresponding counters in the respective service QoE incident reports for the measurement period. In such case, the QoE incident report sent to the RAN node includes the aggregated values, limited to a predetermined maximum count. In some of these embodiments, each service QoE incident report excludes categories of severity whose corresponding counters are zero at the end of the measurement period.

In some of these embodiments, the exemplary method can also include operations of block 1055, where in response to the end of the measurement period, the UE radio layer sends to the one or more services respective requests for service QoE incident reports. The service QoE incident reports are sent by the respective services (e.g., in block 1060) in response to the requests. In some of these embodiments, the exemplary method can also include the operations of block 1070, where the one or more services resetting their respective counters in response to one of the following: sending the service QoE incident report (e.g., in block 1060) or receiving the request for a service QoE incident report (e.g., in block 1055).

In some embodiments, the message (e.g., sent in block 1060) comprises an RRC MeasResults IE that includes the QoE incident report and the results of the radio measurements. FIG. 7 shows an example of these embodiments.

In some embodiments, the one or more services communicate with corresponding one or more application servers via the UE's serving cell in the RAN and the results of the radio measurements are for the UE's serving cell and one or more neighbor cells in the RAN.

In addition, FIG. 11 shows a flow diagram of an exemplary method (e.g., procedure) for a network node or function (NNF) configured to receive UE QoE measurements in a RAN, according to various exemplary embodiments of the present disclosure. The exemplary method can be performed by any appropriate NNF (e.g., base station, eNB, gNB, ng-eNB, NWDAF, MDAF) such as described elsewhere herein.

The exemplary method can include the operations of block 1110, where the NNF can receive a message that includes a QoE incident report and results of radio measurements performed by a UE radio layer during the measurement period. The QoE incident report includes at least one count of incidents that negatively affect user QoE during a measurement period. Each count corresponds to a different one of a plurality of categories of severity and each incident is associated with a service of a UE application layer that includes one or more services that communicate with corresponding one or more application servers via the RAN.

In some embodiments, the plurality of categories of severity include the following:
a first category of critical problems, such that the corresponding service cannot be used;
a second category of major problems, such that the corresponding service is usable but user QoE is seriously degraded; and
a third category of medium problems, such that user QoE for the corresponding service is degraded but less than for a major problem.

In some embodiments, the NNF is a RAN node, the message is received from the UE, and the exemplary method also includes the operations of block 1120, where the NNF (i.e., RAN node) can send the QoE incident report and the results of the radio measurements to one or more of the following: an NWDAF of a core network (e.g., 5GC) coupled to the RAN, and an MDAF of an operations administration maintenance (OAM) system coupled to the RAN. In some of these embodiments, the message (e.g., received in block 1110) comprises an RRC MeasResults IE that includes the QoE incident report and the results of the radio measurements. FIG. 7 shows an example of these embodiments.

In other embodiments, the NNF is an NWDAF of a core network (e.g., 5GC) coupled to the RAN or an MDAF of an OAM system coupled to the RAN, and the message is received from a RAN node that serves the UE. In such embodiments, the exemplary method can also include one or more of the following operations, labelled with corresponding block numbers:
(1130) computing one or more QoE key performance indicators (KPIs) based on the QoE incident report;
(1140) detecting one or more radio-related problems in the RAN based on the QoE incident report and the results of the radio measurements; and
(1150) detecting one or more problems in a core network coupled to the RAN, based on the QoE incident report and the results of the radio measurements.
   Various examples of these operations were discussed above in relation to FIG. 8.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

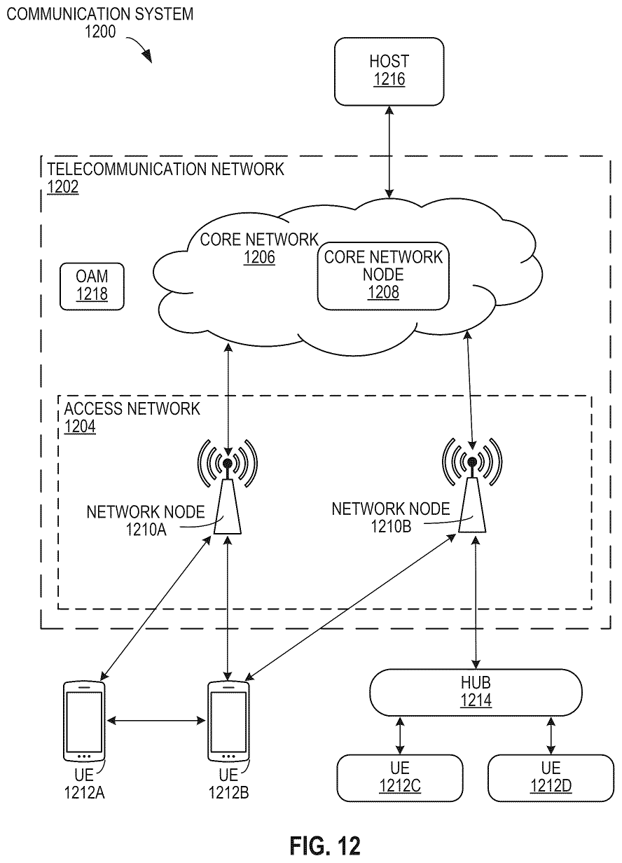

FIG. 12 shows an example of a communication system 1200 in accordance with some embodiments. In this example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be similar to those described with respect to the UEs, network nodes, and/or hosts, such that the descriptions thereof are generally applicable to the corresponding components of the core network node 1208. Example core network nodes (or functions hosted by such nodes) include Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Network Data Analytics Function (NWDAF), and User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a specific example, host 1216 can be an application server that communications with one or more services of a UE application layer via access network 1204, based on which UE 1212 can perform/report QoE measurements and radio measurements, according to various methods or procedures described herein.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

Telecommunication network 1202 may include an operations administration maintenance system (OAM) 1218 that is operably coupled to access network 1204 and core network 1206. OAM 1218 may include one or more OAM nodes or function (not shown), such as a management data analytics function (MDAF) discussed elsewhere herein.

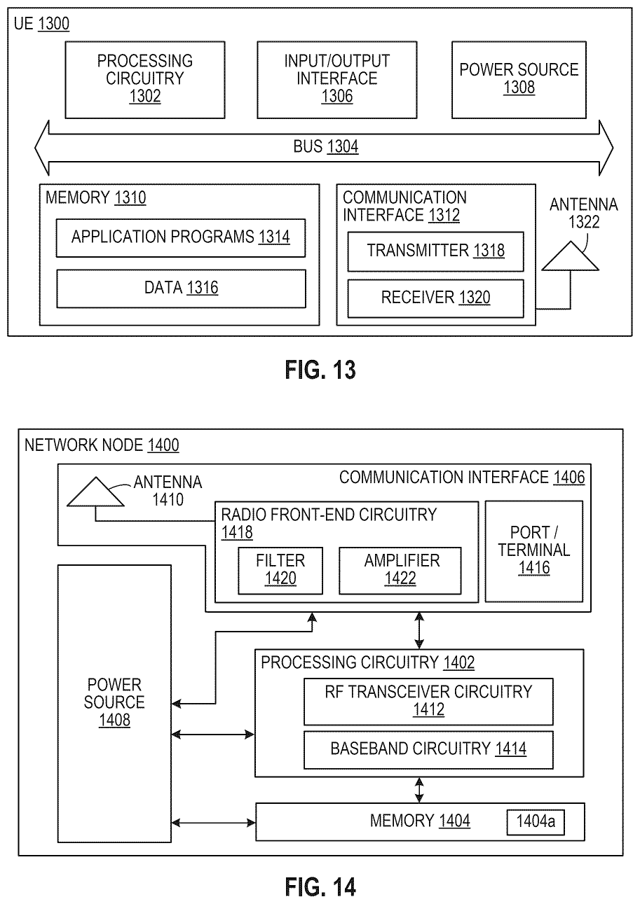

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

As another example, UE 1300 may be configured to report quality of experience (QoE) measurements and radio measurements made by the UE in a RAN. In such case, UE 1300 (and/or its components) may be configured to perform operations attributed to UEs in various methods or procedures described elsewhere herein.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (OAM) nodes, Operations Support System (OSS) nodes, Self-Organizing Network (SON) nodes, core network nodes (or nodes that host core network functions, such as UPF, AMF, NWDAF, etc.), positioning nodes (e.g., E-SMLC, LMF, etc.), and/or Minimization of Drive Testing (MDT) nodes.

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions (collectively referred to as computer program product 1404a) capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

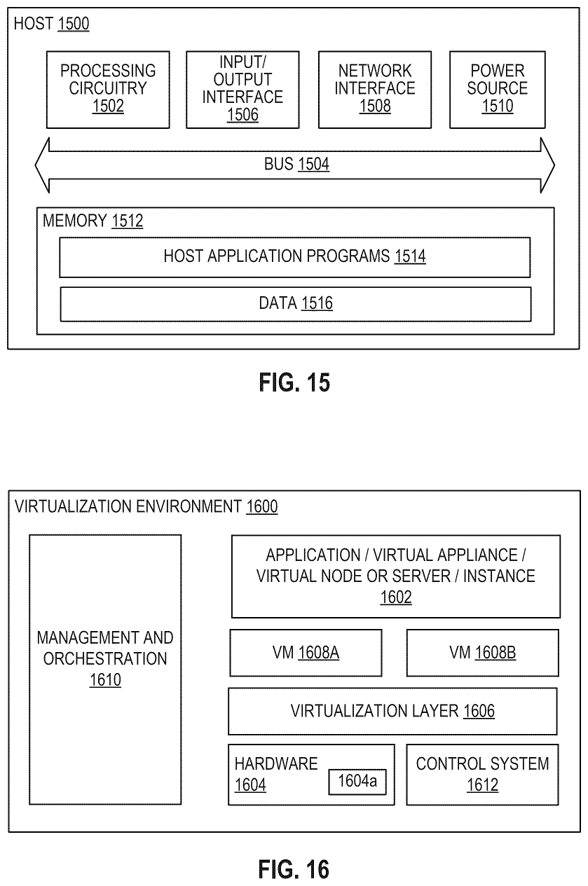

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As a specific example, host 1500 can implement an application server that communications with one or more services of a UE application layer via a RAN, based on which the UE can perform/report QoE measurements and radio measurements, according to various methods or procedures described herein.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

For example, RAN nodes, NWDAF, and/or MDAFs can be implemented as software instances, virtual appliances, network functions, virtual nodes, virtual network functions, etc. in virtualization environment 1600. As a more specific example, these implementations can perform operations attributed to RAN nodes, NWDAF, and/or MDAFs in various methods or procedures described elsewhere herein.

Hardware 1604 includes processing circuitry, memory that stores software and/or instructions (collectively referred to as computer program product 1604a) executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

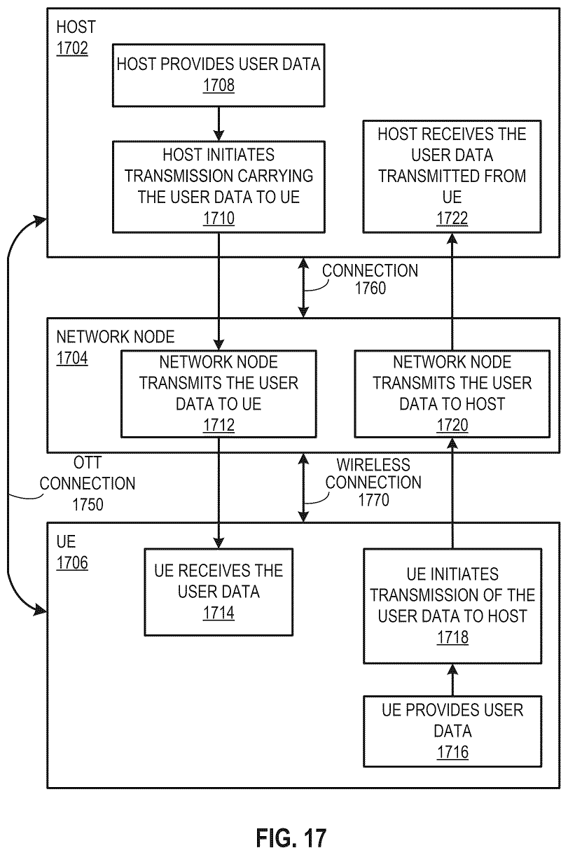

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, embodiments can facilitate more precise QoE estimation than conventional techniques that use QoE machine learning (ML) models. Embodiments can provide QoE-related information in real-time (RT) or near-real time (NRT), which allows using QoE as target optimization parameter in RT or NRT control loops for radio and core self-optimizing network (SON) features. Since QoE and radio-related information are measured during the same period and reported at the same time, QoE incidents are well correlated with underlying radio-related issues, which facilitates root cause identification.

Embodiments also require very little additional measurement collection and reporting, and eliminate or reduce requirements for operators to make agreements with various service providers for back-end interfaces to obtain service provider QoE data. Embodiments provide benefits for both network operators and service providers, which can facilitate and/or encourage implementation of the disclosed techniques by both types of entities. In this manner, embodiments improve network diagnostics of QoE-related issues for OTT services, which increases the value of OTT services, delivered via the network, to end users and service providers.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A method for a user equipment, UE, configured to report quality of experience, QoE, measurements in a radio access network, RAN, the method comprising:
monitoring performance of one or more services, of a UE application layer, that communicate with corresponding one or more application servers via the RAN;
based on the monitoring, detecting one or more incidents that negatively affect user QoE;
classifying each of the incidents as one of a plurality of categories of severity; and
sending, to a RAN node, a message that includes the following:
a QoE incident report that includes at least one count of incidents during a measurement period, with each count corresponding to a different category of severity; and
results of radio measurements performed by a UE radio layer during the measurement period.

2. The method of claim 1, wherein the plurality of categories of severity include the following:
a first category of critical problems, such that the corresponding service cannot be used;
a second category of major problems, such that the corresponding service is usable but user QoE is seriously degraded; and
a third category of medium problems, such that user QoE for the corresponding service is degraded but less than for a major problem.

3. The method of claim 1, wherein the QoE incident report sent to the RAN node includes only non-zero counts of incidents during the measurement period.

4. The method of claim 1, wherein:
the monitoring, detecting, and classifying operations are performed by the respective services of the UE application layer; and
the sending operation is performed by the UE radio layer.

5. The method of claim 4, further comprising:
in response to each incident classified by a particular service, the particular service sending to the UE radio layer a QoE incident report that includes an identifier of the service and the category of severity of the incident; and
the UE radio layer incrementing a counter corresponding to category of severity indicated by incident report.

6. The method of claim 5, wherein the at least one count of incidents in the QoE incident report comprises values of the respective counters at the end of the measurement period, limited to a predetermined maximum count.

7. The method of claim 5, wherein the at least one count of incidents in the QoE incident report excludes categories of severity whose corresponding counters are zero at the end of the measurement period.

8. The method of claim 5, further comprising the UE radio layer resetting the respective counters at or before the beginning of each measurement period.

9. The method of claim 4, further comprising:
in response to each incident classified by a particular service, the particular service incrementing a counter corresponding to category of severity of the incident; and
the respective services sending to the UE radio layer respective service QoE incident reports for the measurement period, with each service QoE incident report including an identifier of the service and values of the service's respective counters at the end of the measurement period.

10. The method of claim 9, wherein:
the one or more services include a plurality of services;
the method further comprises, for each category of severity, the UE radio layer aggregating the values of corresponding counters in the respective service QoE incident reports for the measurement period; and
the QoE incident report sent to the RAN node includes the aggregated values, limited to a predetermined maximum count.

11. The method of claim 9, further comprising:
in response to the end of the measurement period, the UE radio layer sending to the one or more services respective requests for service QoE incident reports, wherein the service QoE incident reports are sent by the respective services in response to the requests; and
the one or more services resetting their respective counters in response to one of the following: sending the service QoE incident report, or receiving the request for a service QoE incident report.

12-13. (canceled)

14. The method of claim 1, wherein the message comprises a radio resource control (RRC) MeasResults information element, IE, that includes the QoE incident report and the results of the radio measurements.

15. The method of claim 1, wherein:
the one or more services communicate with corresponding one or more application servers via the UE's serving cell in the RAN; and
the results of the radio measurements are for the UE's serving cell and one or more neighbor cells in the RAN.

16. A method for a network node or function, NNF, configured to receive user equipment, UE, quality of experience, QoE, measurements in a radio access network, RAN, the method comprising:
receiving a message that includes the following:
a QoE incident report that include at least one count of incidents that negatively affect user QoE during a measurement period, wherein:
each count corresponds to a different one of a plurality of categories of severity, and
each incident is associated with a service of a UE application layer that includes one or more services that communicate with corresponding one or more application servers via the RAN; and
results of radio measurements performed by a UE radio layer during the measurement period.

17-18. (canceled)

19. The method of claim 16, wherein:
the NNF is a RAN node and the message is received from the UE; and
the method further comprises sending the QoE incident report and the results of the radio measurements to one or more of the following:
a network data analytics function, NWDAF, of a core network coupled to the RAN; and
a management data analytics function, MDAF, of an operations administration maintenance, OAM, system coupled to the RAN.

20. (canceled)

21. The method of claim 16, wherein:
the NNF is one of the following:
a network data analytics function, NWDAF, of a core network coupled to the RAN; and
a management data analytics function, MDAF, of an operations administration maintenance, OAM, system coupled to the RAN.
the message is received from a RAN node that serves the UE.

22. The method of claim 21, further comprising one or more of the following:
computing one or more QoE key performance indicators, KPIs, based on the QoE incident report;
detecting one or more radio-related problems in the RAN based on the QoE incident report and the results of the radio measurements; and
detecting one or more problems in a core network coupled to the RAN, based on the QoE incident report and the results of the radio measurements.

23. A user equipment, UE configured to report quality of experience, QoE, measurements in a radio access network, RAN, the UE comprising:
communication interface circuitry configured to communicate with the RAN; and
processing circuitry operatively coupled to the communication interface circuitry, whereby the processing circuitry and the communication interface circuitry are configured to:
monitor performance of one or more services, of a UE application layer, that communicate with corresponding one or more application servers via the RAN;
based on the monitoring, detect one or more incidents that negatively affect user QoE;
classify each of the incidents as one of a plurality of categories of severity; and
send, to a RAN node, a message that includes the following:
a QoE incident report that includes at least one count of incidents during a measurement period, with each count corresponding to a different category of severity; and
results of radio measurements performed by a UE radio layer during the measurement period.

24-26. (canceled)

27. A non-transitory, computer-readable medium storing computer-executable instructions that, when executed by processing circuitry of a user equipment, UE configured to report quality of experience, QoE, measurements in a radio access network, RAN, configure the UE to perform operations corresponding to the method of claim 1.

28-32. (canceled)

33. A non-transitory, computer-readable medium storing computer-executable instructions that, when executed by processing circuitry of a network node or function, NNF configured to receive user equipment, UE quality of experience, QoE, measurements in a radio access network, RAN, configure the NNF to perform operations corresponding to the method of claim 16.

34. (canceled)
